(19) United States
(12) Patent Application Publication
(10) Pub. No.: US 2012/0111528 A1
(43) Pub. Date: May 10, 2012

(54) COOLING DUCT STRUCTURE FOR BATTERY UNIT

(76) Inventors: Tomokazu TAKEUCHI, Hamamatsu-shi (JP); Kunihiro NITAWAKI, Hamamatsu-shi (JP)

(21) Appl. No.: 13/281,820

(22) Filed: Oct. 26, 2011

(30) Foreign Application Priority Data
Nov. 4, 2010 (JP) 2010-247355

(51) Int. Cl. B60H 1/00

(52) U.S. Cl. 165/41

(57) ABSTRACT

A cooling duct structure for a battery unit includes a cooling duct which is located above the battery unit, and extends toward an upper portion of an auxiliary mounting space. The cooling duct is separated into an upper duct and a lower duct in a middle portion thereof. The lower duct is fixedly connected to the battery unit, and can be mounted on the vehicle together with the battery unit. The upper duct and the lower duct, which are separated from each other, can be connected to each other when the battery unit is fixed to and mounted on the vehicle.

### CROSS-RELATED APPLICATIONS

This application claims priority from Japanese Patent Application No. 2010-247355; filed Nov. 4, 2010, the disclosure of which is incorporated herein by reference in its entirety.

### BACKGROUND OF THE INVENTION

The present invention relates to a cooling duct structure for a battery unit, and relates particularly to a cooling duct structure for a battery unit that cools, by using external air, the inside of the battery unit mounted outside a vehicle cabin, for example, under a floor panel.

In recent years, occurrences of resource and environmental problems have been recognized worldwide in terms of the environment and exhaustion of fossil fuel, for example. With this background, various automakers are attempting to commercialize hybrid vehicles (hereinafter, referred to as HEVs) at low prices.

In general, an HEV has batteries inside the vehicle. For this reason, some space in the luggage compartment and the vehicle cabin is taken by the batteries. Especially in the case of electric vehicles, the vehicles travel only by use of batteries, instead of using batteries in conjunction with gasoline engines. Accordingly, an electric vehicle, compared to an HEV, includes a significantly larger number of batteries mounted in the vehicle to ensure a reasonable travel distance, and this makes it difficult to mount all the batteries inside the vehicle cabin.

Moreover, a vehicle using a battery unit that includes, inside a vehicle cabin, a fan and an air vent for cooling the battery, may have a problem that drive noise and wind noise of the cooling fan echo through the inside of the vehicle. To address this problem, it is conceivable to mount the battery unit outside the vehicle cabin, especially under the vehicle body, to secure the space inside the vehicle cabin. Furthermore, to reduce the wind noise, it is conceivable to dispose the cooling fan, a cooling duct and the like, in addition to the battery unit, outside the vehicle cabin.

For example, JP 07-164893 A discloses a cooling duct structure. The vehicle in JP 07-164893 A has a structure in which a battery unit is mounted under the floor, which is outside the vehicle cabin, and the inside of the battery unit is cooled by use of external air. The structure is provided with an air intake and exhaust duct. The air intake and exhaust duct is extended to a high position above the vehicle, and has a volume chamber at an end portion of the air intake and exhaust duct.

However, in the cooling duct structure in which the battery unit is disposed outside the vehicle cabin and the cooling duct is disposed outside the vehicle cabin, a cooling fan and the like are disposed under a floor panel. When the vehicle with this structure travels in rainy weather or on a flooded road, water enters the cooling duct and the cooling fan. If the water comes in contact with the batteries, problems such as short circuits and electric shocks may occur.

Additionally, there has been proposed a cooling duct structure in which a cooling fan is disposed on a battery unit and a cooling duct is disposed to have an opening facing forward. In the case of using this structure, even if the cooling duct is disposed in a space defined by a floor panel surface, water that is raised when the vehicle travels backward or frontward may hit the floor panel surface and then enter the opening of the cooling duct.

Furthermore, if a vehicle including a battery unit mounted under the floor outside the vehicle cabin is also provided with a space for mounting peripheral auxiliary devices under the floor panel, the mounting of the large and heavy battery unit over a wide area and the mounting of the peripheral auxiliary devices need to be conducted in the same space; accordingly the attachment may be difficult.

If the peripheral auxiliary devices are combined with the extremely large and heavy battery unit, the size and weight are further increased. This may cause difficulties in handling the battery unit and the auxiliary devices in various situations such as attaching and detaching of the battery unit and the auxiliary devices, and should hence be better avoided.

If the cooling duct is extended to a high position under the floor panel or the volume chamber (case) is provided at the end portion of the cooling duct, a space is formed between the cooling duct and an upper surface of the battery unit under the cooling duct. In this case, peripheral auxiliary devices are mounted in the space. This causes an extremely difficult situation in that it is desired to mount the cooling duct together with the battery unit considering that the cooling duct is to be connected with the battery unit, while also being desired to mount the auxiliary devices before the cooling duct considering that the auxiliary devices are to be mounted at an intermediate position between the cooling duct and the battery unit.

### SUMMARY OF THE INVENTION

An object of the present invention is to provide a cooling duct structure for a battery unit which can prevent water from entering the inside of a battery unit including an air-cooling structure, can provide an optimal structure for a vehicle having a space for mounting peripheral auxiliary devices as well as a battery unit under a floor panel, and can reduce unnecessary space while facilitating mountability.

The present invention provides a cooling duct structure for a battery unit mounted under a floor panel of a vehicle. The cooling duct structure includes: an auxiliary mounting space protruding upward under the floor panel and being capable of accommodating an auxiliary device; and a cooling duct and a cooling fan configured to take external air to cool a battery in the battery unit and then exhaust the air. The cooling duct is located above the battery unit and extends toward an upper portion of the auxiliary mounting space. The cooling duct is separated into an upper duct and a lower duct in a middle portion thereof. The lower duct is fixedly connected to the battery unit, and is configured to be mounted on the vehicle together with the battery unit. The upper duct and the lower duct, which are separated from each other, are configured to be connected to each other when the battery unit is fixed to and mounted on the vehicle.

The cooling duct structure for a battery unit according to the present invention can ensure that an open end of the cooling duct is disposed at a high position by use of the height of the auxiliary mounting space. This can prevent water from entering the battery unit.

The cooling duct structure for a battery unit according to the present invention allows the cooling duct to be provided to have air tightness even when the entire cooling duct, which is long, is arranged in a position where the battery unit is disposed. Thus, the cooling duct structure also facilitates assembly.

### BRIEF DESCRIPTION OF THE DRAWINGS

FIG. 1 is a plan view of a vehicle body.

FIG. 2 is a perspective view of the vehicle body.

FIG. 3 is a perspective view of the vehicle body and a battery unit detached from the vehicle body.

FIG. 4 is an enlarged cross-sectional view of the vehicle body on which the battery unit is mounted.

FIG. 5 is a plan view of the vehicle body showing a flow of cooling air.

FIG. 6 is a cross-sectional view of a case.

### DETAILED DESCRIPTION OF PREFERRED EMBODIMENTS

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

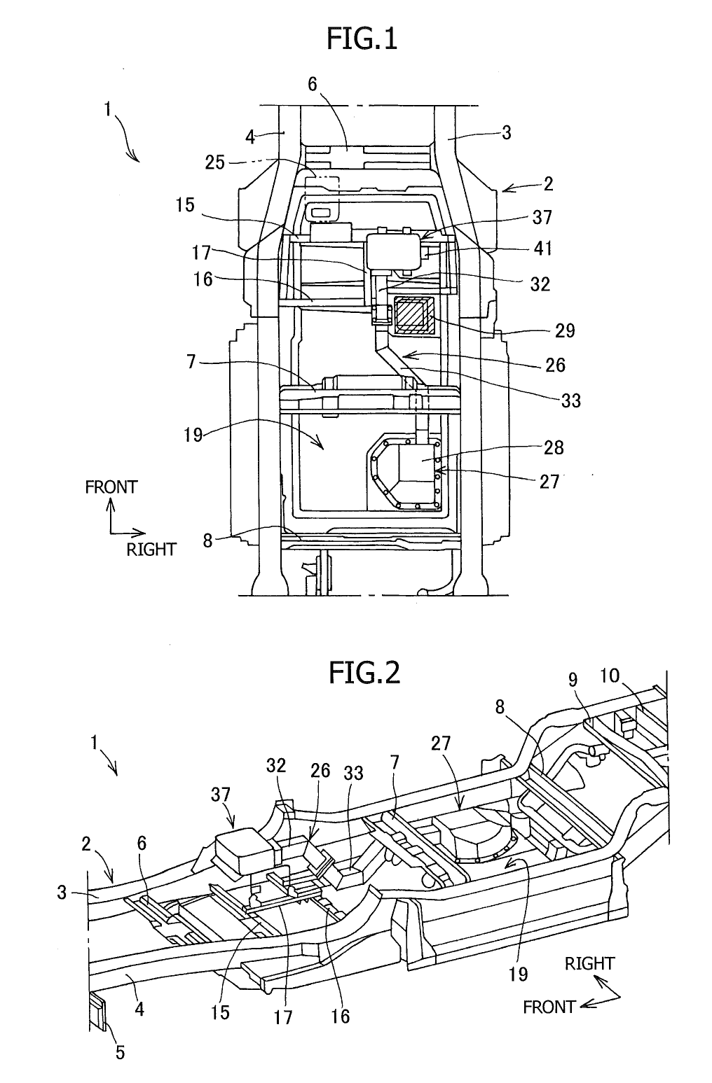

FIGS. 1 to 6 show the embodiments of the present invention. In FIGS. 1 to 3, reference numeral 1 denotes a vehicle, and reference numeral 2 denotes a vehicle body. The vehicle 1 includes, as the vehicle body 2, a pair of a right side frame 3 and a left side frame 4 each extending in the vehicle front-rear direction, multiple cross members 5 to 11 each extending in the right-left direction, and a floor panel 12 (see FIG. 4). As shown in FIGS. 2 to 4, the right side frame 3 and the left side frame 4 are connected with each other by the multiple cross members 5 to 11. The floor panel 12 (see FIG. 4) is disposed on the right side frame 3, the left side frame 4, and the cross members 5 to 11. A vehicle cabin 13 is formed above the floor panel 12.

As shown by a broken line in FIG. 4, an auxiliary mounting space 14 capable of accommodating auxiliary devices is provided under the floor panel 12 located under a front seat. As shown in FIG. 4, the auxiliary mounting space 14 is formed by protruding the floor panel 12 upward, and is a space protruding upward of a battery unit 19. The auxiliary devices are high-voltage electrical parts such as an inverter, and an air-conditioning unit, for example. As shown in FIGS. 1 and 2, auxiliary mounting sub-frames 15, 16 are disposed, which are connected to link the pair of the right side frame 3 and the left side frame 4 provided in the vehicle 1. A sub-member 17 is disposed, which extends in the front-rear direction to connect central portions, in the width direction, of the sub-frames 15, 16. The auxiliary devices are mounted on and fixed to the sub-frames 15, 16 and the sub-member 17.

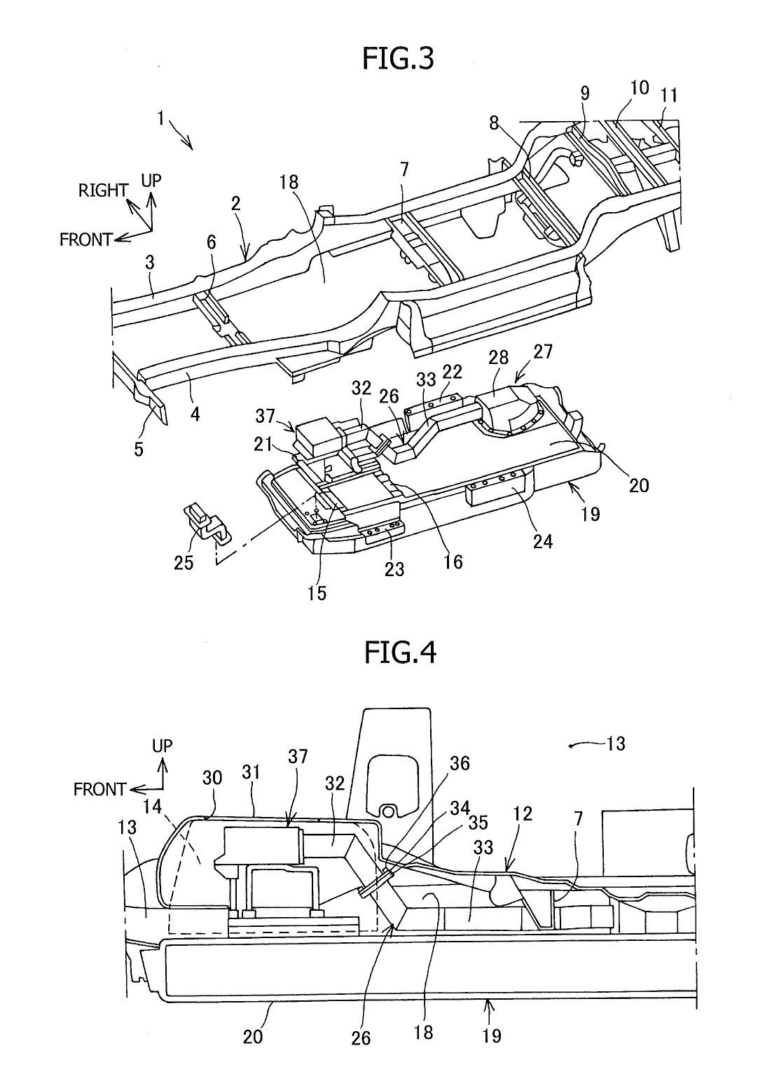

As shown in FIG. 3, the vehicle 1 also has a substantially rectangular-parallelepiped-shaped space 18 under the floor panel 12 located in a middle portion in the front-rear direction. The space 18 has a shape that is long in the front-rear direction, and that is flat in the up-down direction. The space 18 is a space defined by the pair of the right side frame 3 and the left side frame 4, each extending in the vehicle front-rear direction, and the multiple cross members 6 to 8 connecting the side frames 3, 4 with each other. The auxiliary mounting space 14 communicates with a portion, around an upper front end, of the space 18.

The vehicle 1 utilizes the space 18 to mount therein the rectangular-parallelepiped-shaped battery unit 19. The battery unit 19 is located under the space 18 while being arranged to correspond to the center of the space 18. The battery unit 19 includes multiple batteries in a housing 20.

As shown in FIG. 3, the battery unit 19 includes multiple right mount parts 21, 22 and multiple left mount parts 23, 24, respectively on the right and left sides of the housing 20. The right mount parts 21, 22 are spaced from each other in the front-rear direction while the left mount parts 23, 24 are spaced from each other in the front-rear direction. The right mount parts 21, 22 and the left mount parts 23, 24 each protrude in the width direction. The battery unit 19 is firmly fixed to the vehicle body 2 by attaching the right mount parts 21, 22 and the left mount parts 23, 24 respectively to lower surfaces of middle portions, in the front-rear direction, of the paired right side frame 3 and the left side frame 4. In addition, the housing 20 is disposed between the multiple right mount parts 21, 22, arranged to be spaced from each other in the front-rear direction, and the multiple left mount parts 23, 24, arranged to be spaced from each other in the front-rear direction. The housing 20 includes a concave connection part to which a high-voltage cable and the like are connected, in a middle portion of a right side surface of the housing 20, the connection part being formed to be concave toward the inside of the housing 20.

An entire upper surface of the housing 20 of the battery unit 19, as the lower surface, is formed to be a flat surface that is approximately horizontal. On the upper surface of the housing 20, some function parts of the battery unit 19 are provided to protrude upward. In a cooling duct structure for the battery unit 19 thus configured, an air-intake-side cooling duct 25 for taking air for cooling the batteries is disposed around a left front end of the housing 20, while an air-exhaust-side cooling duct 26 for exhausting air for cooling the batteries and a cooling fan 27 are disposed around a right rear end of the housing 20. The air-exhaust-side cooling duct 26 is arranged to extend frontward from a front surface of a fan case 28 of the cooling fan 27 on the right side of the vehicle.

Moreover, as shown in FIG. 1, a service plug part 29 for preventing the conduction of the high-voltage batteries is disposed in a middle portion, on the right side, of the housing 20. Furthermore, as shown in FIG. 4, a service hole 30 for allowing access to the service plug part 29 is formed in a portion, above the service plug part 29, of the floor panel 12. A service panel 31 is detachably attached to the service hole 30.

The air-intake-side cooling duct 25 extends upward to penetrate the floor panel 12, and can take relatively clean air from the inside of the vehicle cabin 13. In the housing 20 of the battery unit 19, the draft-inducing operation of the cooling fan 27 disposed downstream (in a rear portion) of the housing 20 generates cooling wind. The generated cooling wind flows mainly in one direction, and uniformly cools the individual batteries arranged in the housing 20. Hence, the battery unit 19 is an air-cooling type battery unit.

The air-intake-side cooling duct 25, the air-exhaust-side cooling duct 26, the cooling fan 27, and the service plug part 29 are all disposed by use of the substantially rectangular-parallelepiped-shaped space 18, which is long in the front-rear direction and flat in the up-down direction. In the space 18, the multiple cross members 6 to 8, which are positioned in the middle, are arranged to connect the pair of the right side frame 3 and the left side frame 4. Furthermore, in the space 18, the auxiliary mounting sub-frames 15, 16 are arranged to connect the pair of the right side frame 3 and the left side frame 4. The sub-frames 15, 16 are connected with the sub-member 17 extending in the front-rear direction between the middle portions, in the width direction, of the sub-frames 15, 16.

On the rear side of the battery unit 19, a sub-frame for mounting thereon an power unit (not shown) is disposed. The sub-frame is fixed to the pair of the right side frame 3 and the left side frame 4 and the cross members 9 to 11, which are positioned in a rear portion.

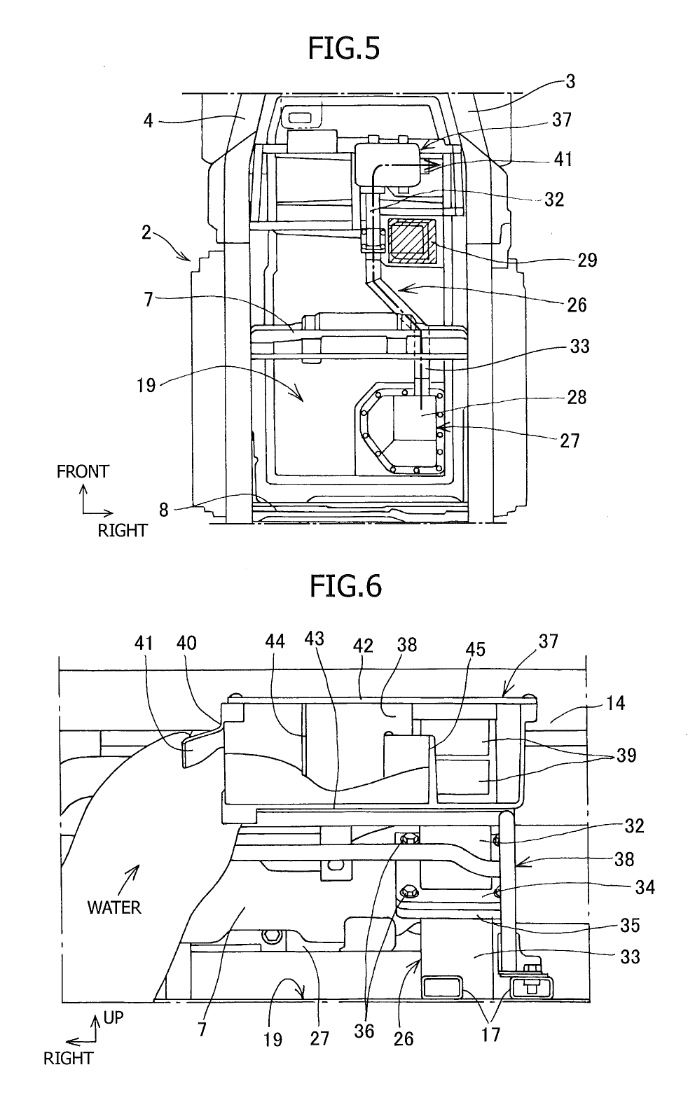

In the battery unit 19, the air-exhaust-side cooling duct 26 is arranged to overlap with the battery unit 19. The air-exhaust-side cooling duct 26 extends in the front-rear direction along the upper surface of the housing 20 on the battery unit 19. As shown in FIG. 5, the air-exhaust-side cooling duct 26 leads exhaust air from the cooling fan 27 toward the front side of the vehicle 1, and exhausts the air. As shown in FIG. 4, the air-exhaust-side cooling duct 26 extends upward toward an upper portion, under the front seat, of the auxiliary mounting space 14 in the battery unit 19. In the battery unit 19, the air-exhaust-side cooling duct 26 is separated into an upper part and a lower part, which are an upper duct 32 on the upper side and a lower duct 33 on the lower side. An upper connection plate 34 and a lower connection plate 35 are attached to the upper duct 32 and the lower duct 33, respectively.

In the battery unit 19, the upper duct 32 and the lower duct 33 can be connected with each other by the upper connection plate 34 and the lower connection plate 35, and the connection is made when the battery unit 19 is mounted on and fixed to the vehicle body 2. To ensure air tightness, the upper duct 32 and the lower duct 33 are firmly connected with each other by fastening the upper connection plate 34 and the lower connection plate 35 to each other by use of a bolt 36. In addition, to allow access to the upper connection plate 34 and the lower connection plate 35 from the service hole 30, the connection direction of the upper connection plate 34 and the lower connection plate 35 is a direction extending from the lower rear side to the upper front side so as to be inclined with respect to the auxiliary mounting space 14. The fastening of the upper connection plate 34 and the lower connection plate 35 with the bolt 36 may be done after mounting of the battery unit 19 on the vehicle 1, or before mounting of the battery unit 19 on the vehicle 1. Alternatively, the fastening is also done by sub-assembly. In this way, the cooling duct structure for the battery unit 19 can make sure that the open end of the air-exhaust-side cooling duct 26 is disposed at a high position by use of the height of the auxiliary mounting space 14. This can prevent water from entering the battery unit 19. Furthermore, the cooling duct structure for the battery unit 19 allows the air-exhaust-side cooling duct 26 to be provided to have air tightness even when the entire air-exhaust-side cooling duct 26, which is long, is arranged in a position in which the battery unit 19 is disposed. Thus, the cooling duct structure also facilitates assembly.

The battery unit 19 may be mounted on the vehicle 1 together with the auxiliary devices in such a manner that the upper duct 32 is arranged above the auxiliary devices disposed in the auxiliary mounting space 14 in the battery unit 19. With this configuration, the cooling duct structure for the battery unit 19 allows the upper duct 32 to be in a high position of the auxiliary mounting space 14, and also allows the upper duct 32 to be mounted together with the auxiliary devices by sub-assembly.

In the battery unit 19, a front end portion of the upper duct 32 on the downstream side is formed as a case 37 having a capacity. The case 37 has a rectangular parallelepiped shape that is long in the width direction of the vehicle 1 and flat in the up-down direction of the vehicle 1. The case 37 allows the upper duct 32 to be arranged in an even higher position, and also allows access to the auxiliary devices while increasing the capacity by enlarging the size in the right-left direction. As shown in FIG. 6, in the battery unit 19, the case 37 is fixed to a case frame 38, which is attached to the auxiliary mounting sub-frames 15, 16 and the sub-member 17, in order to dispose the case 37 at an even higher position. Thus, the case 37 is disposed above the auxiliary mounting space 14. Accordingly, the case 37 can be arranged to be spaced upward from the auxiliary devices disposed in a lower portion of the auxiliary mounting space 14.

Thus, the cooling duct structure for the battery unit 19 has the auxiliary mounting space 14 in a lower position while arranging the case 37 to be spaced from the auxiliary mounting space 14. This configuration allows the case 37 to be arranged in an extremely high position, and can hence prevent water from entering the battery unit 19 even if water reaches a higher level.

As shown in FIGS. 2 and 5, an upstream end portion of the lower duct 33 is fixed to and connected with the fan case 28 of the cooling fan 27 in the battery unit 19. As shown in FIG. 4, the lower duct 33 is arranged to extend substantially horizontally in the vehicle front-rear direction along the upper surface of the housing 20 of the battery unit 19. In this way, the lower duct 33 can be mounted on the vehicle 1 together with the battery unit 19. Moreover, as shown in FIG. 5, the lower duct 33 is cranked to some extent to prevent the lower duct 33 from interfering with other components.

As shown in FIG. 6, an air exhaust port 39, which includes an outer side wall 38 on the rear side to which a main duct portion of the upper duct 32 is connected, is formed in the case 37 of the upper duct 32. In addition, an opening 41 facing downward is fotmed in an outer side wall 40 on the right side spaced from the outer side wall 38 on the rear side, to which the main duct portion of the upper duct 32 is connected. The opening 41 is in a position almost closed by the vehicle body structure including the housing 20 of the battery unit 19, the right side frame 3, the left side frame 4, the cross members 6, 7 and the floor panel 12. Accordingly, powerful water flow is unlikely to reach the opening 41 directly.

As shown in FIG. 6, a water shielding plate 44, extending from an upper plate 42 to a lower plate 43 near the opening 41, and a water shielding plate 45 extending from the lower plate 43 to the upper plate 42 near the air exhaust port 39, are disposed in the case 37. Moreover, the multiple water shielding plates 44, 45 are disposed between the opening 41 and the air exhaust port 39 in the case 37. Accordingly, even if water enters the case 37 from the opening 41, the water is shut out by the water shielding plates 44, 45, and does not flow into the air exhaust port 39.

In this way, the cooling duct structure for the battery unit 19 can reliably prevent water from entering the inside of the battery unit 19. Furthermore, the cooling duct structure for the battery unit 19 can prevent water from entering the battery unit 19 more reliably in cooperation with the structure of the floor panel 12, defining the auxiliary mounting space 14, of the vehicle body 2.

In the above-described embodiment, the case 37 is relatively large to have a large capacity. However, the case 37 may be formed to have a relatively small capacity to improve accessibility to the auxiliary devices and the service plug part 29 on the upper surface of the battery unit 19.

The present invention provides a structure capable of preventing water from entering the inside of the battery unit while facilitating assembly. The present invention may be applicable to a battery unit mounted in a hybrid vehicle as well as an electric vehicle.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed. The following claims are provided to ensure that the present application meets all statutory requirements as a priority application in all jurisdictions and shall not be construed as setting forth the full scope of the present invention.

What is claimed:

1. A cooling duct structure for a battery unit mounted under a floor panel of a vehicle, the cooling duct structure comprising:
an auxiliary mounting space protruding upward under the floor panel and being capable of accommodating an auxiliary device; and
a cooling duct and a cooling fan configured to take external air to cool a battery in the battery unit and then exhaust the air,
wherein the cooling duct is located above the battery unit and extends toward an upper portion of the auxiliary mounting space,
wherein the cooling duct is separated into an upper duct and a lower duct in a middle portion thereof,
wherein the lower duct is fixedly connected to the battery unit, and is configured to be mounted on the vehicle together with the battery unit, and
wherein the upper duct and the lower duct, which are separated from each other, are configured to be connected to each other when the battery unit is fixed to and mounted on the vehicle.

2. The cooling duct structure for a battery unit according to claim 1, wherein the upper duct is disposed above the auxiliary device, and is mounted on the vehicle together with the auxiliary device.

3. The cooling duct structure for a battery unit according to claim 1, wherein
a front end portion of the upper duct is formed as a case having a capacity,
the case is flat in a up-down direction, and
the case is disposed on the upper portion of the auxiliary mounting space while being arranged to be spaced upward from the auxiliary device disposed below the case.

4. The cooling duct structure for a battery unit according to claim 3, wherein
an opening facing downward is formed in an outer side wall of the case, and
a water shielding plate is disposed in the case.

5. The cooling duct structure for a battery unit according to claim 2, wherein
a front end portion of the upper duct is formed as a case having a capacity,
the case is flat in a up-down direction, and
the case is disposed on the upper portion of the auxiliary mounting space while being arranged to be spaced upward from the auxiliary device disposed below the case.

6. The cooling duct structure for a battery unit according to claim 5, wherein
an opening facing downward is formed in an outer side wall of the case, and
a water shielding plate is disposed in the case.
